(19) United States
(12) Patent Application Publication
(10) Pub. No.: US 2026/0027851 A1
(43) Pub. Date: Jan. 29, 2026

(54) MECANUM WHEEL

(71) Applicant: Locus Robotics Cop., Wilmington, MA (US)

(72) Inventors: John Pearlman, Holden, MA (US); Sarah Forman, Watertown, MA (US)

(21) Appl. No.: 18/785,589

(22) Filed: Jul. 26, 2024

(51) Int. Cl. B60B 19/00; B60B 19/12

(52) U.S. Cl. CPC B60B 19/003; B60B 19/125

(57) ABSTRACT

A mecanum wheel includes a first wheel frame having a circumference and a plurality of first mounting mechanisms spaced about the circumference. There is a second wheel frame having a circumference and a like plurality of second mounting mechanisms spaced about the circumference. There are a plurality of roller units, each having a roller surface and a hollow center cavity. There is an axle disposed in the hollow center cavity of each roller, and a first end of the axle is connected a first mounting mechanisms and the second end of each axle is connected to the second mounting mechanism. The first end of each axle includes an angled tip portion with a substantially flat surface.

### TECHNICAL FIELD

The present invention relates to improvements in the design of omnidirectional wheels and more particularly to the design of mecanum wheels for use with robots.

### BACKGROUND ART

Robots working in factories, wheelchairs moving into place on a bus, moon-landers and other motorized vehicles all need to move omnidirectionally in a compact and facile manner. The mecanum wheel, patented in the US in 1975 as U.S. Pat. No. 3,876,255 provides a widely adopted solution to this problem. A vehicle equipped with four mecanum wheels can, by independently varying the speed and rotational direction of each wheel, move in a straight line at any angle from its current position.

Despite their many advantages, mecanum wheels as currently designed may suffer from a loosening of component parts, resulting in shimmying and creating noise and, in some cases, failure of the mecanum wheel. A need exists for improved designs to address these and related issues.

### SUMMARY OF THE EMBODIMENTS

According to an embodiment of this disclosure, there is a mecanum wheel including a first wheel frame having a circumference and a plurality of first mounting mechanisms spaced about the circumference. There is a second wheel frame having a circumference and a like plurality of second mounting mechanisms spaced about the circumference; each of the plurality of second mounting mechanisms having a corresponding first mounting mechanism. There are a plurality of roller units, each having a roller surface and a hollow center cavity and an axle disposed in the hollow center cavity. The axle has a first end extending outside of a first end of the hollow center cavity and is connected to one of the first mounting mechanisms of the first wheel frame and the axle has a second end extending outside of a second end of the hollow center cavity and is connected to the corresponding second mounting mechanisms of the second wheel frame. The first end of each axle includes an angled tip portion with a substantially flat surface.

In another embodiment one or more of the following features may be included. Each first mounting mechanism may include an elastic compression piece having a first surface disposed on the substantially flat surface of the angled tip portion of the first end of the axle. The elastic compression piece may comprise an elastomer. Each first mounting mechanism may include a cover piece in contact with a second surface of the compression piece and may be configured to compress the compression piece against the substantially flat surface of the angled tip portion of the first end of the axle. The substantially flat surface of the angled tip portion of the first end of the axle may be parallel to an external surface the first wheel frame and the cover piece may be mounted on the external surface of the first wheel frame. The cover piece may be adjustably attached to the first wheel frame so that compression of the elastic compression piece can be increased or decreased. The cover piece may be adjustably attached to the first wheel frame by a screw and turning the screw in one direction may increase the compression of the elastic compression piece and turning the screw in an opposite direction may decrease the compression of the elastic compression piece. Each second mounting mechanism may include a surface having a centrally located concave region to receive the second end of the axle. Each second mounting mechanism may include an integrated washer disposed about the concave region and the integrated washer may contact a set of bearings on the roller unit disposed about a circumference of the hollow center cavity at the second end of the hollow center cavity. The first end of the axle may include a flange proximate the angled tip portion, the flange contacting the first end of the hollow center cavity.

According to an embodiment of this disclosure, there is a mecanum wheel having a first wheel frame having a circumference and a plurality of first mounting mechanisms spaced about the circumference and a second wheel frame having a circumference and a like plurality of second mounting mechanisms spaced about the circumference, each of the plurality of second mounting mechanisms having a corresponding first mounting mechanism. There are a plurality of roller units, each having a roller surface and a hollow center cavity. There is an axle disposed in the hollow center cavity, the axle having a first end extending outside of a first end of the hollow center cavity and connected to one of the first mounting mechanisms of the first wheel frame and having a second end extending outside of a second end of the hollow center cavity and connected to the corresponding second mounting mechanisms of the second wheel frame. The first end of each axle includes an angled tip portion with a substantially flat surface and each first mounting mechanism includes an elastic compression piece having a first surface disposed on the substantially flat surface of the angled tip portion of the first end of the axle.

In further embodiments one or more of the following features may be included. The elastic compression piece may comprise an elastomer. Each first mounting mechanism may include a cover piece in contact with a second surface of the compression piece and may be configured to compress the compression piece against the substantially flat surface of the angled tip portion of the first end of the axle. The substantially flat surface of the angled tip portion of the first end of the axle may be parallel to an external surface of the first wheel frame and the cover piece may be mounted on the external surface of the first wheel frame. The cover piece may be adjustably attached to the first wheel frame so that compression of the clastic compression piece can be increased or decreased. The cover piece may be adjustably attached to the first wheel frame by a screw and turning the screw in one direction may increase the compression of the elastic compression piece and turning the screw in an opposite direction may decrease the compression of the elastic compression piece. Each second mounting mechanism may include a surface having a centrally located concave region to receive the second end of the axle. Each second mounting mechanism may include an integrated washer disposed about the concave region; the integrated washer contacting a set of bearings on the roller unit disposed about a circumference of the hollow center cavity at the second end of the hollow center cavity. The first end of the axle may include a flange proximate the angled tip portion, the flange contacting the first end of the hollow center cavity.

According to yet another embodiment of this disclosure, there is a mecanum wheel with a first wheel frame having a circumference and a plurality of first mounting mechanisms spaced about the circumference and a second wheel frame having a circumference and a like plurality of second mounting mechanisms spaced about the circumference, each of the plurality of second mounting mechanisms having a corresponding first mounting mechanism. There are a plurality of roller units, each having a roller surface and a hollow center cavity. There is an axle disposed in the hollow center cavity. The axle has a first end extending outside of a first end of the hollow center cavity and connected to one of the first mounting mechanisms of the first wheel frame and a second end extending outside of a second end of the hollow center cavity and connected to the corresponding second mounting mechanisms of the second wheel frame. The first end of each axle includes an angled tip portion with a substantially flat surface and a flange proximate the angled tip portion. Each first mounting mechanism includes an elastic compression piece having a first surface disposed on the substantially flat surface of the angled tip portion of the first end of the axle and the flange contacts the first end of the hollow center cavity. Each second mounting mechanism includes a surface having a centrally located concave region to receive the second end of the axle and each second mounting mechanism includes an integrated washer disposed about the concave region. The integrated washer contacts a set of bearings on the roller unit disposed about a circumference of the hollow center cavity at the second end of the hollow center cavity.

### BRIEF DESCRIPTION OF THE DRAWINGS

The foregoing features of embodiments will be more readily understood by reference to the following detailed description, taken with reference to the accompanying drawings, in which:

FIG. 1 provides a perspective view of a mecanum wheel with a design according to the prior art.

FIG. 2 provides a cross-sectional view of a roller in the mecanum wheel of FIG. 1.

FIG. 3 provides a perspective view of a mecanum wheel according to an aspect of the this disclosure.

FIG. 4 provides a cross-sectional view of a roller of the mecanum wheel of FIG. 3.

FIG. 5 provides a cut-out view of a portion of a first mounting mechanisms for the roller of the mecanum wheel according to this disclosure.

FIG. 6 depicts the external side of a mini-cover for the first mounting mechanism of FIG. 5.

FIG. 7 depicts the internal side of the mini-cover of FIG. 6.

FIG. 8 is a side view the rotor axle as shown in FIG. 4.

FIG. 9 is a perspective view of a compression piece according to an aspect of this disclosure for holding the axle in place.

FIG. 10 is an enlarged perspective view of a cylindrical recess and integrated washer of a second mounting mechanism according to an aspect of this disclosure

### DETAILED DESCRIPTION OF SPECIFIC EMBODIMENTS

The disclosure and the various features and advantageous details thereof are explained more fully with reference to the non-limiting embodiments and examples that are described and/or illustrated in the accompanying drawings and detailed in the following description. Various aspects of the subject matter discussed in greater detail below may be implemented in any of numerous ways, as the subject matter is not limited to any particular manner of implementation. Examples of specific implementations and applications are provided primarily for illustrative purposes.

Unless otherwise defined, used, or characterized herein, terms that are used herein (including technical and scientific terms) are to be interpreted as having a meaning that is consistent with their accepted meaning in the context of the relevant art and are not to be interpreted in an idealized or overly formal sense unless expressly so defined herein. The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms “includes,” “including,” “comprises,” and “comprising” specify the presence of the stated elements or steps but does not preclude the presence or additional of one or more other elements or steps.

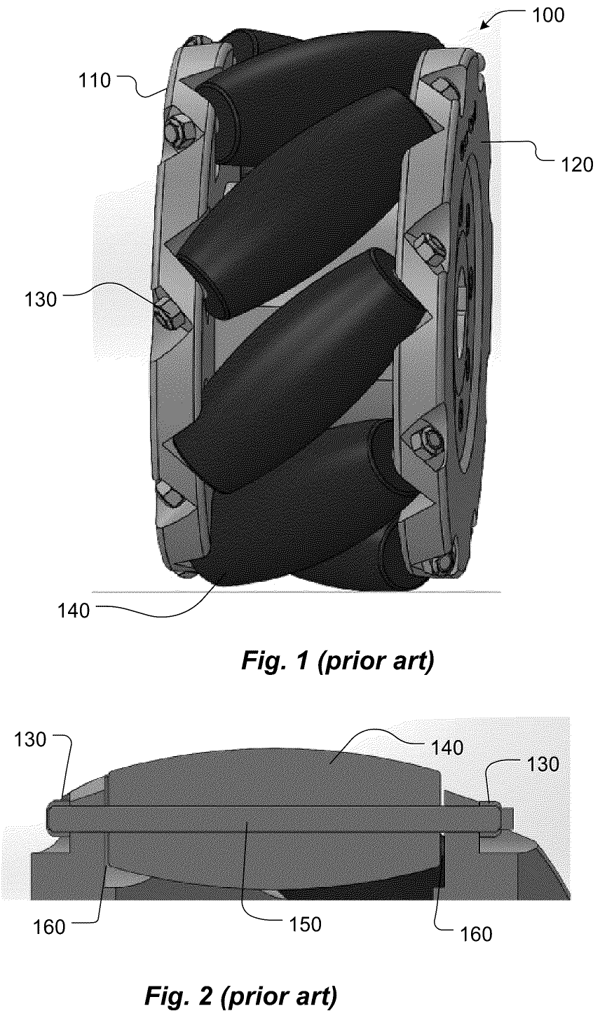

A prior art design of a mecanum wheel 100 is shown in FIGS. 1 and 2 to include a plurality of rollers 140 obliquely disposed between two wheel frames 110 and 120. Each wheel frame is a circular structure having a rim and the plurality of rollers 140 are disposed about the circumference of the frames. Each roller 140 is held in place by nuts 130 on either end of a roller axle (not visible in this view), affixing the axle to wheel frames 110 and 120 and allowing the rollers to freely rotate as mecanum wheel 100 turns.

A cross-sectional view of a portion of mecanum wheel 100 is shown in FIG. 2 depicting how nuts 130 are screwed onto each end of an axle 150 longitudinally disposed through a hollow central region of roller 140. According to this prior art design, nuts 130, which may be made of nylon, are screwed in place to retain axle 150 and hold the roller 140 in position on the wheel frames 110 and 120. Gaps 160 between bearings (not shown) on the roller 140 and the wheel frames 110 may be filled with washers of various sizes, in order to shim the rollers 140 to hold them securely in place.

However, due to the imprecision of the shims, axial play between the rollers 140 may result in movement and vibration of the roller 140 causing shaking, noise and a loosening of components. Over time the nuts may come off the axle and the axles may scrape against the ground causing them to wear and possibly break. These problems are eliminated with the mecanum wheel design of the present disclosure, which holds the rollers firmly in place without the need to fill gaps with washers. This eliminates shimmying, reduces noise, and eliminates the problem of nuts loosening and causing the axle and rollers to fail.

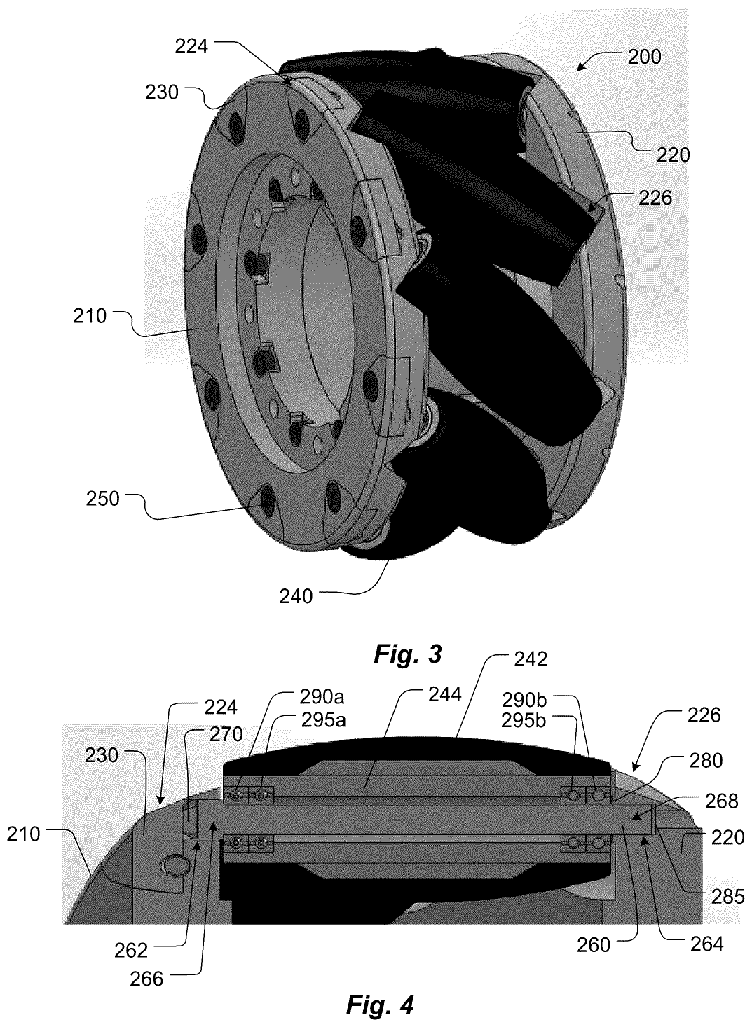

FIG. 3 depicts an embodiment of a mecanum wheel 200 according to the current disclosure. The wheel comprises a first wheel frame 210 and a second wheel frame 220 having a plurality of roller units 240 obliquely disposed between the two wheel frames 210, 220. The roller units 240 are mounted at a first end into a plurality of first mounting mechanisms 224 about the circumference of wheel frame 210 and they are mounted at a second end in a corresponding plurality of second mounting mechanisms 226 about the circumference of the wheel fram 220. Each of the first mounting mechanisms 224 includes a cover piece 230 affixed to wheel frame 210 via a screw 250 to lock the roller units in place, as described in more detail below.

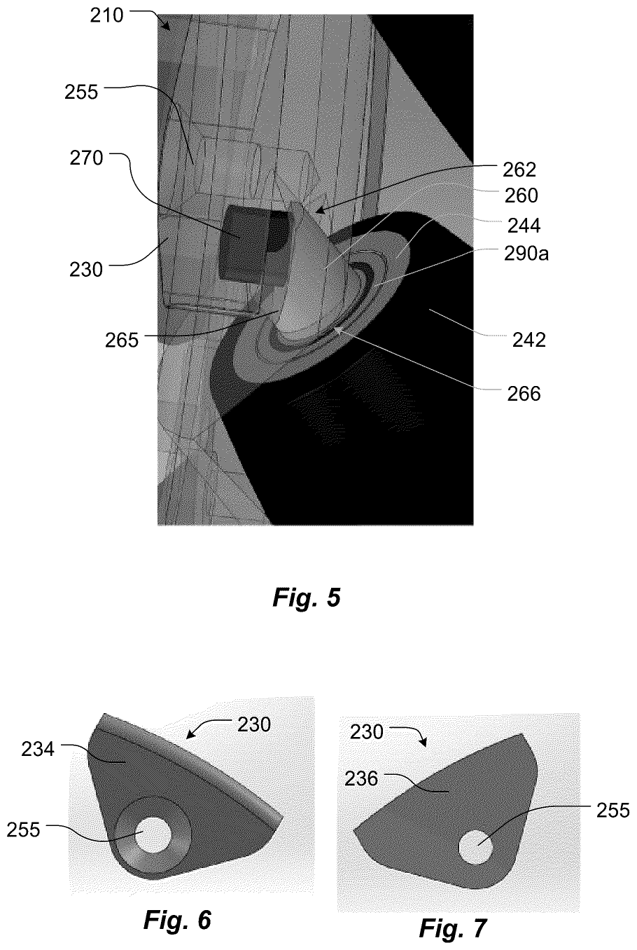

Referring to FIGS. 4 and 5 a more detailed depiction of mecanum wheel 200 is provided. In FIG. 4 a cross-sectional view of roller unit 240, affixed between wheel frames 210, 220 is shown. In FIG. 5 a close up, cut-out view of a portion of a first mounting mechanism 224 for the roller unit 240 is shown.

As depicted, roller unit 240 includes a roller surface 242 mounted on a roller support 244. In the center of roller support 244 and running longitudinally through the center of roller support 244 is a hollow center cavity through which an axle 260 is disposed. Axle 260 has a first end 262 extending outside of a first end 266 of the hollow center cavity and connected to one of the first mounting mechanisms 224 of the first wheel frame 210 and having a second end 264 extending outside of a second end 268 of the hollow center cavity and connected to the corresponding second mounting mechanisms 226 of the second wheel frame 220.

Continuing to refer to FIGS. 4 and 5, first end 262 of roller axle 260 in first mounting mechanism 224 receives an angled tip portion 265 with a substantially flat surface, on which is disposed a compression piece 270. The flat surface is substantially parallel with the cover piece 230 (as shown in FIG. 5) and an outer surface of wheel frame 210. According to this embodiment, one end of the axle 260 of each roller 240 is held in place by a compression piece 270, which may be constructed of an elastic material. The compression piece 270 is sandwiched between cover piece 230 and the substantially flat surface of the angled tip portion 265 of the axle 260. The compression piece 270 is fixed in place against the cover piece 230 by screw 250. The compression of the compression piece may be varied changing the durometer of the compression piece.

As can be seen in the cross-sectional view of FIG. 4, ball bearing set 290a/b are affixed to either end of roller support 244 in the hollow center cavity and are in contact with axle 260 to facilitate rotation of the roller unit 240 about axle 260. An additional set of ball bearings 295a/b are also affixed to roller support 244 inside of hollow center cavity and in contact with axle 260 to facilitate rotation of the roller unit 240. Ball bearing set 290a/b is located at the first end 266 and second end 268 of hollow center and ball bearing set 295a/b are positioned adjacent to and inside of ball bearing set 290a/b.

At first end 266 of hollow center cavity ball bearings 290a are in contact with a flange portion on first end 262 of axle 260 and second end 264 of axle 260 sits in a central concave region 285 of second mounting mechanisms 226. Ball bearings 290b are in contact built in or integrated washer 280 which is more clearly depicted in FIG. 10. Turning the screw 250 so as to increase the compression of the compression piece 270 against the angled tip portion 265 of the axle 260, in turn pushes flange portion on first end 262 of axle 260 against the ball bearings 290a. This forces ball bearings 290b against the built-in or integrated washer 280, thereby firmly holding the roller 240 in place between frames 210 and 220 and eliminating shimmying, and the noise and loosening of components associated therewith.

FIGS. 6-10 show isolated embodiments of the individual components of the mecanum wheel 200 that is disclosed herein.

FIG. 6 depicts an embodiment of the external side 234 of the cover piece 230 against which the compression piece 270 pushes, showing the screw hole 255 into which a screw is inserted in order to tighten the cover piece 230 against the compression piece 270, thereby causing the compression piece 270 to exert pressure against the angled tip portion 265 of the rotor axle 260. According to some embodiments, an indentation on the external side 234 of the cover piece 230 allows the screw 250 to sit flush with the surface of the cover piece 230. FIG. 7 shows the internal side of the cover piece of FIG. 6. The internal side being the side which contacts the compression piece 270.

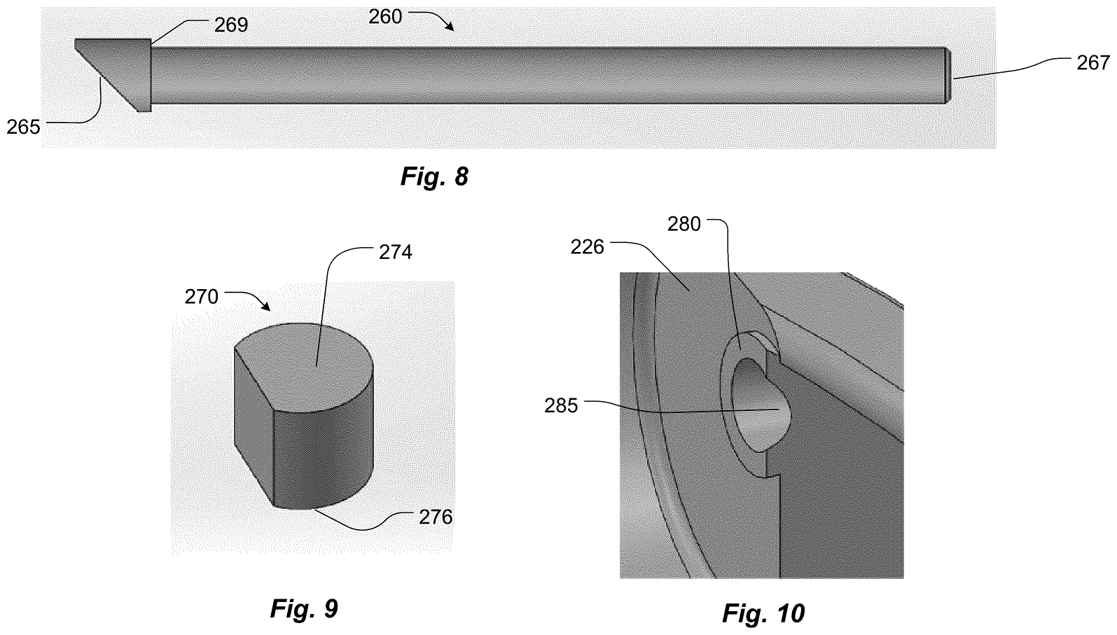

FIG. 8 depicts an embodiment of axle 260, which traverses the hollow center cavity of each roller unit 240. The angled tip portion 265 at one end allows the compression piece 270 to be held firmly in place against the cover piece 230. Angled tip portion 265 also provides an anti-rotation function (which eliminates the need for keyways, set screw, D profile, etc.) to fix axle 260 from rotating relative to 210 and 220

At the opposite end from the angled tip portion 265, the cylindrical end 267 of the axle 260 fits into a concave recess 285 in the second mounting mechanism 226, as described above and depicted in a close up view in FIG. 10. As noted above, set of bearings 290b is pressed against the built-in washer 280, in a manner controllable by the cover piece screw 250.

FIG. 9 is an embodiment of the compression piece 270 that may be sandwiched between the angled end of the rotor axle and the internal side of the cover piece. One surface 274 presses against the inner surface 236 of the cover piece 230, and the opposite surface 276 presses against the angled tip portion 265 of the axle 260.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A mecanum wheel comprising:
a first wheel frame having a circumference and a plurality of first mounting mechanisms spaced about the circumference,
a second wheel frame having a circumference and a like plurality of second mounting mechanisms spaced about the circumference; each of the plurality of second mounting mechanisms having a corresponding first mounting mechanism;
a plurality of roller units, each having:
a roller surface and a hollow center cavity;
an axle disposed in the hollow center cavity, the axle having a first end extending outside of a first end of the hollow center cavity and connected to one of the first mounting mechanisms of the first wheel frame and having a second end extending outside of a second end of the hollow center cavity and connected to the corresponding second mounting mechanisms of the second wheel frame; and
wherein the first end of each axle includes an angled tip portion with a substantially flat surface.

2. The mecanum wheel of claim 1, wherein each first mounting mechanism includes an elastic compression piece having a first surface disposed on the substantially flat surface of the angled tip portion of the first end of the axle.

3. The mecanum wheel of claim 2, wherein the elastic compression piece comprises an elastomer.

4. The mecanum wheel of claim 2, wherein each first mounting mechanism includes a cover piece in contact with a second surface of the compression piece and configured to compress the compression piece against the substantially flat surface of the angled tip portion of the first end of the axle.

5. The mecanum wheel of claim 4, wherein the substantially flat surface of the angled tip portion of the first end of the axle is parallel to an external surface the first wheel frame and the cover piece is mounted on the external surface of the first wheel frame.

6. The mecanum wheel of claim 5, wherein the cover piece is adjustably attached to the first wheel frame so that compression of the elastic compression piece can be increased or decreased.

7. The mecanum wheel of claim 6, wherein the cover piece is adjustably attached to the first wheel frame by a screw and turning the screw in one direction increases the compression of the elastic compression piece and turning the screw in an opposite direction decreases the compression of the elastic compression piece.

8. The mecanum wheel of claim 4, wherein each second mounting mechanism includes a surface having a centrally located concave region to receive the second end of the axle.

9. The mecanum wheel of claim 8, wherein each second mounting mechanism includes an integrated washer disposed about the concave region; the integrated washer contacting a set of bearings on the roller unit disposed about a circumference of the hollow center cavity at the second end of the hollow center cavity.

10. The mecanum wheel of claim 9, wherein the first end of the axle includes a flange proximate the angled tip portion, the flange contacting the first end of the hollow center cavity.

11. A mecanum wheel comprising:
a first wheel frame having a circumference and a plurality of first mounting mechanisms spaced about the circumference,
a second wheel frame having a circumference and a like plurality of second mounting mechanisms spaced about the circumference; each of the plurality of second mounting mechanisms having a corresponding first mounting mechanism;
a plurality of roller units, each having:
a roller surface and a hollow center cavity;
an axle disposed in the hollow center cavity, the axle having a first end extending outside of a first end of the hollow center cavity and connected to one of the first mounting mechanisms of the first wheel frame and having a second end extending outside of a second end of the hollow center cavity and connected to the corresponding second mounting mechanisms of the second wheel frame;
wherein the first end of each axle includes an angled tip portion with a substantially flat surface; and
wherein each first mounting mechanism includes an elastic compression piece having a first surface disposed on the substantially flat surface of the angled tip portion of the first end of the axle.

12. The mecanum wheel of claim 11, wherein the elastic compression piece comprises an elastomer.

13. The mecanum wheel of claim 11, wherein each first mounting mechanism includes a cover piece in contact with a second surface of the compression piece and configured to compress the compression piece against the substantially flat surface of the angled tip portion of the first end of the axle.

14. The mecanum wheel of claim 13, wherein the substantially flat surface of the angled tip portion of the first end of the axle is parallel to an external surface of the first wheel frame and the cover piece is mounted on the external surface of the first wheel frame.

15. The mecanum wheel of claim 14, wherein the cover piece is adjustably attached to the first wheel frame so that compression of the elastic compression piece can be increased or decreased.

16. The mecanum wheel of claim 15, wherein the cover piece is adjustably attached to the first wheel frame by a screw and turning the screw in one direction increases the compression of the elastic compression piece and turning the screw in an opposite direction decreases the compression of the elastic compression piece.

17. The mecanum wheel of claim 13, wherein each second mounting mechanism includes a surface having a centrally located concave region to receive the second end of the axle.

18. The mecanum wheel of claim 17, wherein each second mounting mechanism includes an integrated washer disposed about the concave region; the integrated washer contacting a set of bearings on the roller unit disposed about a circumference of the hollow center cavity at the second end of the hollow center cavity.

19. The mecanum wheel of claim 18, wherein the first end of the axle includes a flange proximate the angled tip portion, the flange contacting the first end of the hollow center cavity.

20. A mecanum wheel comprising:
a first wheel frame having a circumference and a plurality of first mounting mechanisms spaced about the circumference;
a second wheel frame having a circumference and a like plurality of second mounting mechanisms spaced about the circumference; each of the plurality of second mounting mechanisms having a corresponding first mounting mechanism;
a plurality of roller units, each having:
a roller surface and a hollow center cavity;
an axle disposed in the hollow center cavity, the axle having a first end extending outside of a first end of the hollow center cavity and connected to one of the first mounting mechanisms of the first wheel frame and having a second end extending outside of a second end of the hollow center cavity and connected to the corresponding second mounting mechanisms of the second wheel frame; and
wherein the first end of each axle includes an angled tip portion with a substantially flat surface and a flange proximate the angled tip portion;
wherein each first mounting mechanism includes an elastic compression piece having a first surface disposed on the substantially flat surface of the angled tip portion of the first end of the axle and wherein the flange contacts the first end of the hollow center cavity;
wherein each second mounting mechanism includes a surface having a centrally located concave region to receive the second end of the axle; and
wherein each second mounting mechanism includes an integrated washer disposed about the concave region; the integrated washer contacting a set of bearings on the roller unit disposed about a circumference of the hollow center cavity at the second end of the hollow center cavity.
